(19) United States
(12) Patent Application Publication
(10) Pub. No.: US 2002/0000443 A1
(43) Pub. Date: Jan. 3, 2002

(54) Enclosure thermal shield

(76) Inventor: Rick C. Hunter, Friendswood, TX (US)

Correspondence Address: BRYAN L. WHITE, Bracewell & Patterson, L.L.P., PO Box 61389, Houston, TX, 77208-1389, US

(21) Appl. No.: 09/898,588

(22) Filed: Jul. 3, 2001

Related U.S. Application Data
(60) Provisional application No. 60/215,713, filed on Jul. 3, 2000.

(51) Int. Cl. A47J 41/00; B65D 83/72

(52) U.S. Cl. 220/592.26

(57) ABSTRACT

An enclosure thermal shield has a thermally insulated open container, a thermally insulated closure member, a thermally conductive liner along the container's inner surface and along the inner surface of the closure member forming a thermal circuit when the closure member closes the container, and a heat reservoir in thermal contact with the thermal circuit. The heat reservoir can be placed within the container or incorporated into the closure member. If incorporated into the closure member, the heat reservoir can be placed in direct thermal contact with the thermal circuit or connected to the thermal circuit via a thermal conduit. The thermal shield can further comprise a layer of insulating material lining the interior surface of the conductive liner to further inhibit heat transfer into or out of the interior chamber of the container. The thermal shield and method for directing heat flow regulate the thermal environment of the chamber.

This application claims the benefit of U.S. Provisional Application No. 60/215,713 filed Jul. 3, 2000.

### BACKGROUND OF THE INVENTION

1. Field of the Invention

This invention relates to a thermally insulated container, and more particularly to a thermally insulated container having a thermal shield designed to conduct thermal energy to or from a heat reservoir to maintain a uniform temperature within the container.

2. Description of Prior Art

Prior insulated containers rely on the thermal resistivity of the material comprising the container and convection currents and a heat reservoir within the container chamber to maintain a desired thermal environment within the container. A typical prior art container designed to maintain cool temperatures is a polystyrene plastic box with ice or a frozen gelpack inside the box's payload region. A significant problem with this approach is the heat flux through the box walls. Depending on the thermal resistivity of the insulation and the ambient temperature outside the box, the heat leak into the box can be significant. The resulting heat load must be convectively carried to the heat reservoir to maintain constant temperature within the box.

Note a similar problem exists in reverse if a hot product is the payload and a heat source such as a hot brick is the heat reservoir. Everything stated below will be limited to the cold payload situation, but the present invention is not limited to that.

Prior art insulated containers have proved unsuitable for products that require tight temperature tolerances. Excessive heat gain can exhaust the heat reservoir, causing the temperature to rise rapidly with additional heat gain. Temperature variation can exceed tolerances because the heat reservoir may absorb too much heat from the product itself, lowering its temperature to an unacceptable level. The temperature gradient within the payload volume may be unacceptably large because the warmer air that accumulates near the top of the container is somewhat removed from the colder air surrounding the heat reservoir. Depending on the extent of temperature gradient, a payload could conceivably be too cold at the lower end and too warm on the upper end.

### SUMMARY OF THE INVENTION

The present invention uses an innovative design to produce an enclosure thermal shield having a thermally insulated open container, a thermally insulated closure member, a thermally conductive liner along the container's inner surface and along the inner surface of the closure member that forms a thermal circuit when the closure member closes the container, and a heat reservoir in thermal contact with the thermal circuit. The heat reservoir can be placed within the container or incorporated into the closure member. If incorporated into the closure member, the heat reservoir can be placed in direct thermal contact with the thermal circuit or connected to the thermal circuit via a thermal conduit. The thermal shield can further comprise a layer of insulating material lining the interior surface of the conductive liner to further inhibit heat transfer into or out of the interior chamber of the container. The thermal shield and method for directing heat flow regulate the thermal environment of the chamber.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is a cross section of an elevation view of a first embodiment of an enclosure thermal shield constructed in accordance with the present invention.

FIG. 2 is a cross section of an elevation view of a second embodiment of an enclosure thermal shield constructed in accordance with the present invention.

FIG. 3 is a cross section of an elevation view of a third embodiment of an enclosure thermal shield constructed in accordance with the present invention.

### DETAILED DESCRIPTION

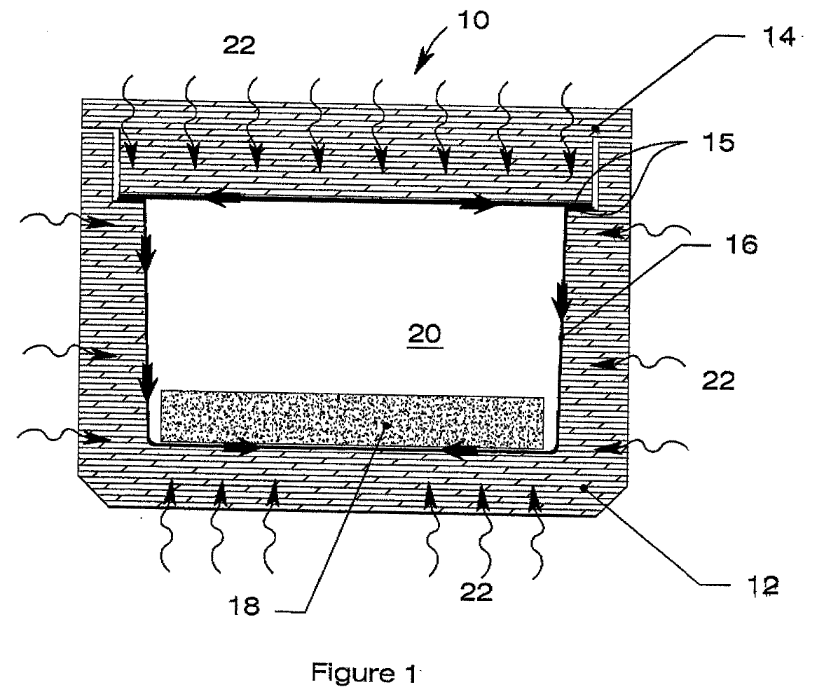

Referring to FIG. 1, enclosure thermal shield 10 comprises an open container 12 and closure member 14, both of which are constructed using a highly thermally resistive material such as polystyrene plastic or vacuum insulation panels. Thermally conductive liner 16 lines the interior surface of container 12 and the lower surface of closure member 14. Container 12 and closure member 14 each have a shoulder 15 which abut when closure member 14 closes container 12. Closure member 14 fits snugly in container 12 to form an airtight seal and, when shoulders 15 are in abutting contact, thermally conductive liner 16 is also in abutting contact to complete a thermal circuit for conductive liner 16. Heat reservoir 18 is placed in container 12 in thermal contact with liner 16.

As stated above, heat reservoir 18 can be hot or cold, depending on the application. An ideal heat reservoir remains at a constant temperature independent of the amount of heat put onto or withdrawn from it. Thus, a heat reservoir is useful as a thermostatic device because it will maintain a constant temperature for the environment in thermal contact with it. Heat reservoir 18 approximates an ideal heat reservoir, but actually is more like a heat sink or source in the sense it generally either absorbs or delivers heat, depending on the application. We choose the term “heat reservoir” because the thermal mass of the material being used as a heat reservoir will generally be large relative to the anticipated heat load, such that the temperature of the heat reservoir will not change appreciably during its expected period of use. “Heat reservoir” also conveys the idea that it can absorb or deliver heat, although as a practical matter it generally is intended to do one or the other. For ease of discussion, the description below shall be limited to the cold temperature/heat sink scenario.

In such a situation, it is anticipated that the enclosure thermal shield 10 will be placed in an ambient environment that is warmer than the desired temperature of a payload. Thus, there will be a net flux of heat toward the container's interior chamber 20. Ordinarily, heat 22 (represented by squiggly arrows in figures) would pass through the thermally resistive material comprising container 12 and closure member 14. Without conductive liner 16, heat 22 would enter chamber 20. However, conductive liner 16 absorbs heat 22 and directs it to heat reservoir 18. Heat reservoir 18 absorbs the infiltrated heat 22 and traps it within the reservoir 18. Thus, the infiltrated heat 22 is intercepted and transported away from the container's interior chamber. The embodiment of FIG. 1 relies on convection to minimize the thermal gradient in chamber 20.

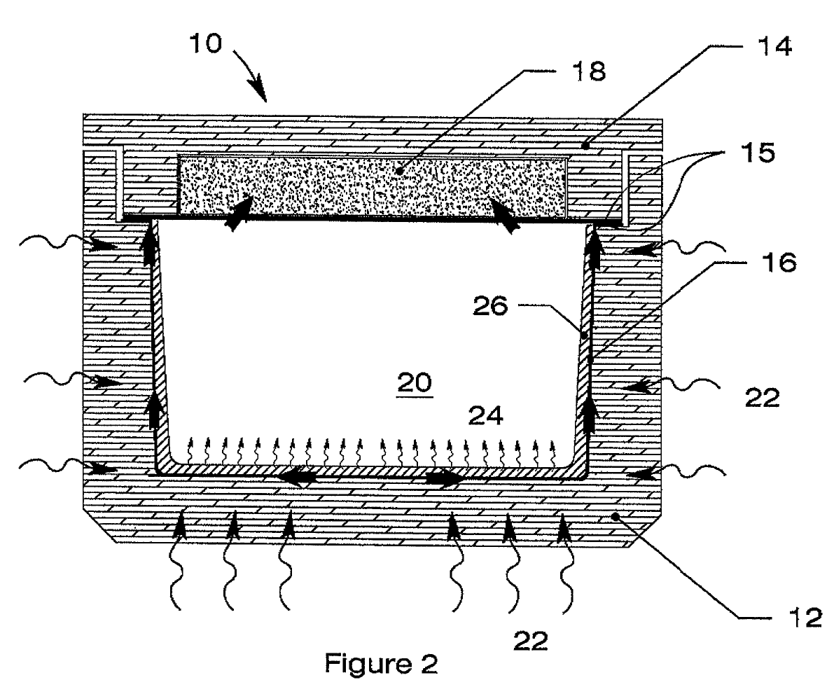

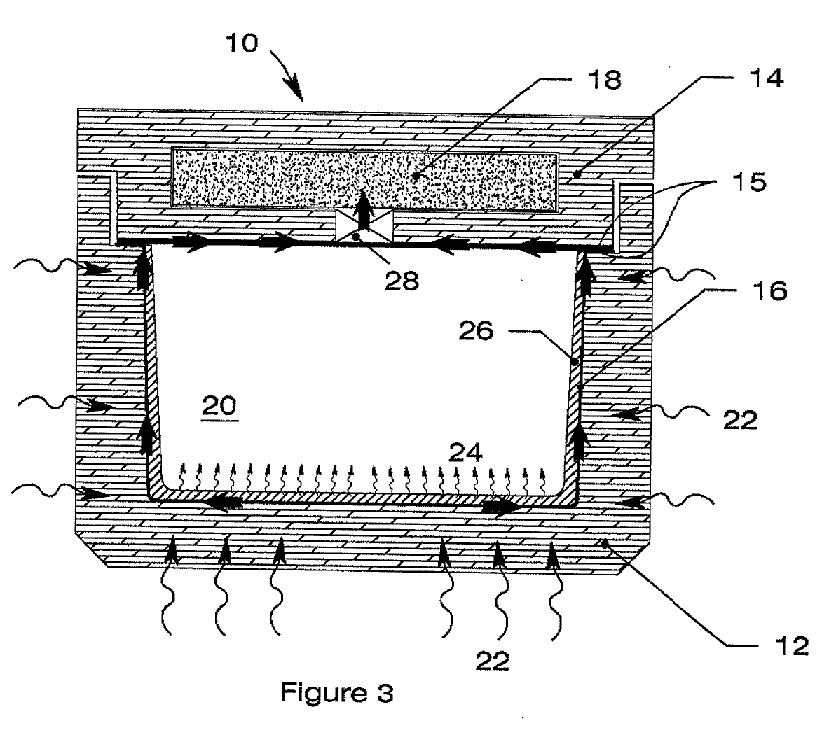

While the vast majority of heat 22 will be conducted into heat reservoir 18, it is possible that some of heat 22 will radiate or conduct from conductive liner 16 and enter chamber 20 as heat 24 (represented by small squiggly arrows in FIGS. 2 and 3). The embodiments of FIGS. 2 and 3 add insulation layer 26 onto the interior surface of conductive liner 16. Insulation layer 26 reduces heat transfer from liner 16 into chamber 20. Thus, very nearly all of infiltrated heat 22 is conducted into heat reservoir 18, minimizing the amount of heat 24 that actually enters chamber 20.

FIGS. 2 and 3 show heat reservoir 18 in closure member 14 instead of within chamber 20 as was done in the embodiment of FIG. 1. In FIG. 2, heat reservoir 18 is placed in direct thermal contact with the outer surface of liner 16. Placing heat reservoir 18 in closure member 14 allows for greater payload capacity and allows one to chill heat reservoir 18 and closure member 14 as a unit in anticipation of enclosure thermal shield's 10 next application. Having beat reservoir 18 on top also increases the convection efficiency when used to cool chamber 20 and minimizes the temperature gradient within chamber 20.

In FIG. 3, heat reservoir 18 is within closure member 14, but separated from liner 16 by the insulation material of closure member 14. Heat reservoir 18 is thermally linked to liner 16 by thermal conduit 28. Conduit 28 allows one to control the rate of heat transfer into heat reservoir 18. For example, conduit 28 can be a thermal conductor sized according to expected heat loads and the desired temperature range within chamber 20 to regulate heat transfer. Thermal conduit 28 can also comprise a thermally resistive material. Additional alternative embodiments for conduit 28 include an air passage, a material that switches state, a thermoelectric device, or a thermal switch.

The present invention offers many advantages over the prior art. The temperature gradient within a container using the thermal shield varies less than in prior art containers. By placing less demand on convection for heat transfer, the temperature within the container is better regulated. Using a thermal conduit allows use of a subcooled heat reservoir without risk of excess heat transfer, thus precluding the possibility of a product being destroyed as a result of excess chilling.

While the invention has been particularly shown and described with reference to a preferred and alternative embodiments, it will be understood by those skilled in the art that various changes in form and detail may be made therein without departing from the spirit and scope of the invention.

What is claimed is:

1. An enclosure thermal shield comprising:
an open container defining a chamber surrounded by walls formed of thermal insulation material;
a closure member having a layer of thermal insulation material for opening and closing the container;
a first thermally conductive layer lining an interior surface of the walls of the container; and
a heat reservoir in thermal contact with the first thermally conductive layer.

2. The thermal shield of claim 1 further comprising a second thermally conductive layer lining an interior surface of the closure member, the first thermally conductive layer being in thermal contact with the second conductive layer to form a thermal circuit when the closure member closes the container.

3. The thermal shield of claim 1 in which the heat reservoir is in the chamber of the container.

4. The thermal shield of claim 1 in which the heat reservoir is recessed within the closure member.

5. The thermal shield of claim 2 in which the heat reservoir is recessed within the closure member and separated from the chamber by a portion of the insulation material of the closure member, and further comprising a thermal conduit extending through said portion of insulation material for thermally connecting the heat reservoir and the thermal circuit.

6. The thermal shield of claim 2 in which the heat reservoir is recessed within the closure member and separated from the chamber by a portion of the insulation material of the closure member, and further comprising a thermal conduit extending through said portion of insulation material for thermally disconnecting the heat reservoir and the thermal circuit.

7. The thermal shield of claim 1 in which the heat reservoir is recessed within the closure member and further comprising a thermally insulating layer lining an interior surface of the first thermally conductive layer.

8. The thermal shield of claim 1 in which the heat reservoir is supported on a bottom of the chamber.

9. The thermal shield of claim 1 in which the heat reservoir is a phase change material.

10. The thermal shield of claim 2 in which:
the container has a lower shoulder on which the first thermally conductive layer is supported;
the closing member has an upper shoulder on which the second thermally conductive layer is supported; and
the lower shoulder and the upper shoulder abut when the closing member closes the container, placing the first thermal conductive layer in abutting contact with the second thermally conductive layer.

11. The thermal shield of claim 1 in which the heat reservoir is at a higher temperature than the ambient temperature of the chamber.

12. The thermal shield of claim 1 in which the heat reservoir is at a lower temperature than the ambient temperature of the chamber.

13. An enclosure thermal shield comprising:
an open container defining a chamber surrounded by walls formed of thermal insulation material;
a closure member having a layer of thermal insulation material for opening and closing the container;
a first thermally conductive layer lining an interior surface of the walls of the container;
a second thermally conductive layer lining an interior surface of the closure member, the first thermally conductive layer being in thermal contact with the second conductive layer to form a thermal circuit when the closure member closes the container;
a layer of thermal insulation material lining an interior surface of the first thermally conductive layer; and
a heat reservoir in thermal contact with the thermal circuit.

14. The thermal shield of claim 13 in which the heat reservoir is in the chamber of the container.

15. The thermal shield of claim 13 in which the heat reservoir is recessed within the closure member.

16. The thermal shield of claim 13 in which the heat reservoir is recessed within the closure member and separated from the chamber by a portion of the insulation material of the closure member, and further comprising a thermal conduit extending through said portion of insulation material for thermally connecting the heat reservoir and the thermal circuit.

17. The thermal shield of claim 13 in which the heat reservoir is supported on a bottom of the chamber.

18. The thermal shield of claim 13 in which the heat reservoir is a frozen gel.

19. The thermal shield of claim 13 in which:
the container has a lower shoulder on which the first thermally conductive layer is supported;
the closing member has an upper shoulder on which the second thermally conductive layer is supported; and
the lower shoulder and the upper shoulder abut when the closing member closes the container, placing the first thermal conductive layer in abutting contact with the second thermally conductive layer.

20. The thermal shield of claim 13 in which the heat reservoir is at a substantially different temperature than the ambient temperature of the chamber.

21. A method of thermally isolating a chamber interior, comprising the steps of:
providing a thermally insulated open container and a thermally insulated closure member;
lining an interior surface of the thermally insulated open container and an interior surface of the thermally insulated closure member with a thermally conductive material to form a thermal circuit when the closure member closes the container; and
placing a heat reservoir in thermal contact with the thermal circuit.

22. The method of claim 21 further comprising the step of:
lining an interior surface of the thermally conductive material lining the interior of the container with a layer of thermally insulating material.
